(19) United States
(12) Patent Application Publication
(10) Pub. No.: US 2007/0299835 A1
(43) Pub. Date: Dec. 27, 2007

(54) SEARCH ENGINE FOR SOFTWARE COMPONENTS AND A SEARCH PROGRAM FOR SOFTWARE COMPONENTS

(76) Inventor: Masaru TAKEUCHI, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/745,614

(22) Filed: May 8, 2007

(30) Foreign Application Priority Data
May 9, 2006 (JP) 2006-130023

(51) Int. Cl. G06F 17/30

(52) U.S. Cl. 707/4

(57) ABSTRACT

To investigate software connectability quickly with higher precision when creating an application from a combination of software components, there is provided a search engine for software components including: a software component repository (303) which stores a set having, as elements, ranges that define input and output of a plurality of software components; a range set higher-order graph database (301) which has a higher-order graph used to manage a union of output range sets of the software components, an input range, and identifiers of the software components; and a component combination search function (2303) which receives a range of a software component to be extracted from the higher-order graph, and searches, based on the received range, the union of output range sets in the higher-order graph for a parallel combination of software components or a single software component having the range as an output.

### CLAIM OF PRIORITY

The present application claims priority from Japanese application P2006-130023 filed on May 9, 2006, the content of which is hereby incorporated by reference into this application.

### BACKGROUND OF THE INVENTION

This invention relates to a method and system for creating an application by compositing software components.

Recently, studies on combining a plurality of software components to automatically create an application (program) that provides a new function have been made as a way of improving productivity of software (see, for example, JP 10-149280 A, and Katsuhiko Sakaue et al., “Learning of Image Processing Strategies in the Recognition Mechanism Learning System MIRACLE-IV”, The Technical Report of the Institute of Electronics, Information and Communication Engineers, Jun. 16, 1988, PRU 88-16-20, 21-29, vol. 88, No. 77, 78, PRU-88-20, pp. 33-40).

According to a conventional technique disclosed in JP 10-149280 A, an attempt has been made to improve the efficiency of application composition by classifying software components by function and utilizing the classification in genetic algorithms. Non-patent Document 1 discloses a conventional technique of automatically compositing image recognition programs through the genetic algorithms.

### SUMMARY OF THE INVENTION

In composing a new application from a combination of a plurality of software components, software components connected need to have input/output matching with each other. When connecting two software components, it is necessary to examine whether an input of one software component matches with an output of another software component. In a case where one software component is given, to search a plurality of software components for a single software component that is connectable to the given software component, it is necessary to check all the output (range) of those software components whether they are connectable or not.

In the above-mentioned conventional examples, studies have been made on a combination of input/output ranges in connecting a single software component with another single software component. However, no studies have been made on a combination of input/output ranges of software components in connecting a parallel combination of software components with another parallel combination of software components. There is no guarantee that an application (program) created from a combination according to the conventional examples operates normally.

In a case of searching a plurality of software components for a combination of a given software component and a software component connectable thereto, it is necessary to check connectability for every combination of the given software component and all the software components. This leads to another problem that the process of inspecting the connectability imposes a heavy computational load.

The above-mentioned genetic algorithms is an algorithm for obtaining an optimum solution by repeating a process of preparing a population of solution candidates, evaluating the solution candidates, preferentially selecting highly evaluated solution candidates, combining solution candidates through a process called crossover, and partially rewriting a solution candidate through a process called mutation to generate a new solution candidate. In genetic algorithms, when a solution candidate newly created through crossover or mutation is not evaluative, this solution candidate is commonly called a solution candidate that has a lethal gene. It is necessary to prevent lethal genes from being generated in genetic algorithms practices.

In a case of automatically creating an application from software components by using genetic algorithms, there is a problem in that an application as a solution candidate cannot be executed unless software components are connectable in the crossover process and the mutation process.

This invention has been made in view of the above-mentioned problems, and it is therefore an object of this invention to investigate the software connectability quickly with higher precision when creating an application from a combination of software components.

According to the present invention, there is provided a search program for software components, which causes a computer to execute a processing of searching a plurality of preset software components for software components that meet an entered condition, the search program for software components causes the computer to execute the steps of: storing a set having, as elements, ranges that define input and output of a plurality of software components; setting a higher-order graph which is used to manage a union of output range sets and an input range of the software components, and identifiers of the software components; receiving a range of a software component to be extracted from the higher-order graph; and searching, based on the received range, the union of output range sets in the higher-order graph for one of a parallel combination of software components and a single software component having the received range as an output.

Further, the search program for software components further includes the step of creating an application from search results of the search unit by using genetic algorithms. The step of creating an application includes the steps of: selecting at random the software components to create a plurality of applications, set the created software components as a population of solution candidates, and initializing the population of solution candidates; evaluating the applications in the population of solution candidates; choosing one application out of the plurality of applications based on a result of the evaluation; creating a next generation population of applications by replacing a part of the chosen application with other software components; and replacing a part of the chosen application with randomly selected other software components to create a new population of applications, and updating the population of solution candidates. The step of initializing includes receiving as ranges an input range and an output range that are set in advance, and combines software components retrieved in the step of searching, to create a plurality of applications.

According to this invention, in a search for a combination of software components that outputs a range set, a family of subsets (union) of the universal set of ranges that is structured in advance in a higher-order graph is utilized to find a connectable combination of software components instead of judging the connectability for each combination of software components. The search efficiency is therefore improved. In this way, the connectability of software components can be investigated quickly with higher precision.

In automatic application creation by using genetic algorithms, this invention creates solution candidates by searching a set of input ranges of software components for a connectable combination of software components instead of directly judging the connectability of software components in the processes of initialization, crossover, and mutation. Producing a solution candidate that is not evaluative is thus avoided. The software productivity is thus greatly improved.

### BRIEF DESCRIPTION OF THE DRAWINGS

FIG. 1 is a block diagram of a software component management system according to this invention.

FIG. 2 is an explanatory diagram of an application configuration example.

FIG. 3 is an explanatory diagram of a graph.

FIG. 4 is an explanatory diagram of a directed graph.

FIG. 5 is an explanatory diagram of a bipartite graph.

FIG. 6 is an explanatory diagram of a bipartite graph derived from a graph.

FIG. 7 is an explanatory diagram of edges expressed in a graph in the manner of a bipartite graph.

FIG. 8 is an explanatory diagram of directed edges expressed in a directed graph in the manner of a bipartite graph.

FIG. 9 is an explanatory diagram of higher-order edges expressed in a higher-order graph in the manner of a bipartite graph.

FIG. 10 is an explanatory diagram of directed higher-order edges expressed in a directed higher-order graph in the manner of a bipartite graph.

FIG. 11A is an explanatory diagram of a range set higher-order graph.

FIG. 11B is an explanatory diagram of a range set higher-order graph in which higher-order edges are connected.

FIG. 12 is an explanatory diagram showing the data configuration of a range set higher-order edge graph.

FIG. 13 is a problem analysis diagram (PAD) showing the processing process of a component registration function.

FIG. 14 is a PAD showing the processing process of a component combination search function.

FIG. 15 is a PAD showing the processing process of a recursion processing process of the component combination search function.

FIG. 16 is a block diagram of an automatic application creating system using genetic algorithms according to a second embodiment.

FIG. 17 is an explanatory diagram of genetic algorithms according to the second embodiment.

FIG. 18 is a PAD showing a processing process for an example in which genetic algorithms are applied to automatic application composition according to the second embodiment.

FIG. 19 is a PAD showing the processing process of a component combination random creation function according to the second embodiment.

FIG. 20 is a PAD showing a processing process for creating a partial application from input and output range sets according to the second embodiment.

FIG. 21 is an explanatory diagram of a processing process for creating a partial application according to the second embodiment.

FIG. 22 is a PAD showing the processing process of partial application building processing according to the second embodiment.

FIG. 23 is a data configuration diagram of a partial application graph according to the second embodiment.

FIG. 24 is a data configuration diagram of a range-component 2-tuple multiset according to the second embodiment.

FIG. 25 is a PAD of an initialization process in genetic algorithms according to the second embodiment.

FIG. 26 is a PAD of a mutation process in the genetic algorithms according to the second embodiment.

FIG. 27 is a PAD of a crossover process in the genetic algorithms according to the second embodiment.

FIG. 28 is an explanatory diagram of a result of partial application removal according to the second embodiment.

### DETAILED DESCRIPTION OF THE PREFERRED EMBODIMENTS

Embodiments of this invention will be described below with reference to the accompanying drawings.

### First Embodiment

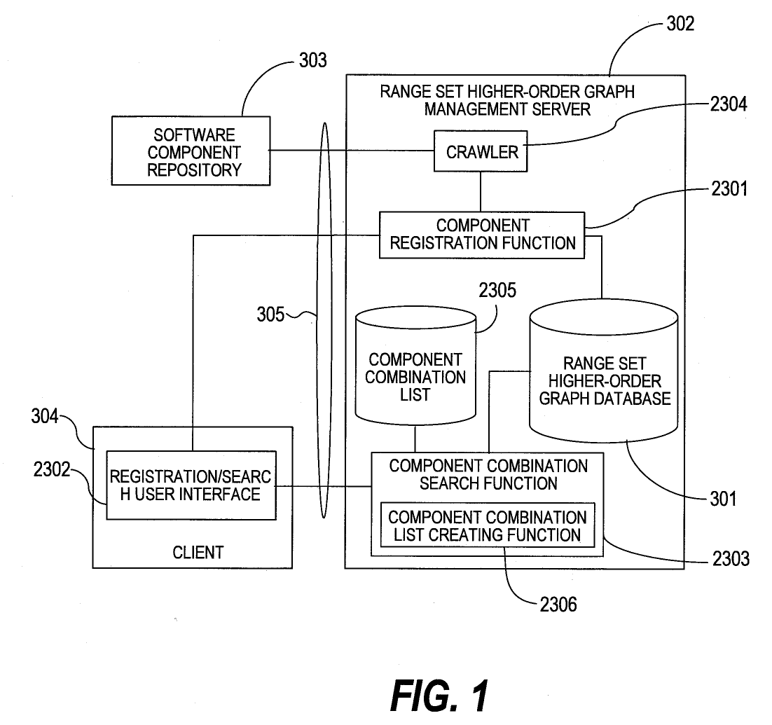

FIG. 1 is a block diagram of a computer system according to a first embodiment. The first embodiment provides a computer system (software component management system) that manages connection information of software components.

In FIG. 1, a range set higher-order graph data server 302, which manages a range set higher-order graph database 301, a software component repository 303, which manages function specifications and input/output specifications of software components, and a client (client computer) 304, which executes a user interface and an application, are connected via a network 305. The range set higher-order graph database 301 stores a range set higher-order graph, which will be described later. The range set higher-order graph data server 302 and the client 304 each have a CPU, a memory, and storage, which are not shown in the drawing. The range set higher-order graph data server 302 functions as the core of the software component management system according to this invention.

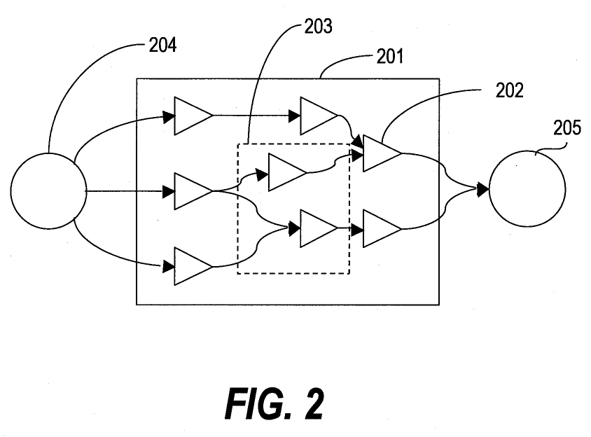

The client 304 searches, in a manner described below, the range set higher-order graph database 301 for a combination of software components stored in the software component repository 303, and builds an application 201 shown in FIG. 2 by combining a plurality of software components. The software component repository 303 stores, as elements, ranges which define the input and output of a plurality of software components. The range set higher-order graph database 301 manages a union of output range sets for each element of the software component repository 303 in a manner to be described later.

An application 201 of FIG. 2 is composed of a plurality of components 202. A part of the application is called a partial application 203. The application 201 and the components 202 input and output in a manner set in advance. A set of such input/output ranges is called a range set. For example, a reference numeral 204 of FIG. 2, an input range set of the application 201 and 205 of FIG. 2 denotes an output range set of the application 201.

Software components considered here are components or Web services. The application 201 is activated upon reception of an input, and outputs a result of performing given processing. In the following description, the term component refers to the software component.

In FIG. 1, the range set higher-order graph data server 302 storing the range set higher-order graph database 301 is composed of a component registration function 2301, a component combination search function 2303, and a crawler 2304. The component registration function 2301 registers, in the range set higher-order graph database 301, information for determining the connectability of the components 202 that are stored in the software component repository 303. The component combination search function 2303 searches, in response to an inquiry from a registration/search user interface 2302 executed in the client 304, for a result about the connectability of a combination of components, and outputs the component search result as a component combination list 2305. The crawler 2304 autonomously searches the software component repository 303, and registers information for determining the connectability. The component combination search function 2303 searches the range set higher-order graph database 301 in response to inquiry from the client 304 and, when a range set that meets a search condition is found, activates a component combination list creating function 2306 to create the component combination list 2305, and provides the list to the client 304. The component registration function 2301 registers information of the components 202 in the range set higher-order graph database 301 in response to request from the crawler 2304 or from the registration/search user interface 2302 of the client 304. Details of the above-mentioned functions will be discussed later. The above-mentioned functions can be implemented as software modules.

The input and output of the components 202 are written, in most cases, in XML as shown in the following example.

```
<Tag0>
  <TagA>ValueA</TagA>
  <TagB>ValueB</TagB>
  <TagC>ValueC</TagC>
</Tag0> .........  Expression (1)
<Tag1>
  <TagA>ValueA</TagA>
  <Tag2>
    <TagB>ValueB</TagB>
    <TagC>ValueC</TagC>
  </Tag2>
<Tag1> .........  Expression (2)
<Tag3>
  <TagD>ValueD</TagD>
  <TagE>ValueE</TagE>
</Tag3> .........  Expression (3)
```

The input/output considered in this embodiment is a set of values obtained by flattening the XML of the above-mentioned Expressions (1) to (3). For instance, when two of the above-mentioned Expressions (2) and (3) are flattened, Expressions (1) to (3) are read as follows.

<TagA>ValueA</TagA>
<TagB>ValueB</TagB>
<TagC>ValueC</TagC>
<TagD>ValueD</TagD>
<TagE>ValueE</TagE> ......... Expression (4)

Expression (4) is deemed as the following set of values.

{ValueA,ValueB,ValueC,ValueD,ValueE} Expression (5)

Further, managed in this invention is a range of values. It is assumed a case where the ranges of the values A to E are shown as follows.

ValueAεRangeA,ValueBεRangeB,ValueCεRangeC,ValueDεRangeD,ValueEεRangeE Expression (6)

### In this case, information to be managed is the input range set 204 shown as follows.

{RangeA,RangeB,RangeC,RangeD,RangeE} Expression (7)

### Examples of the range of values include “product number”, “color”, “size”, and “number of pieces”. A range set including those ranges is as follows.

{Product number,color,size,number of pieces} Expression (8)

Described next is a higher-order graph that constitutes a range set higher-order graph 501.

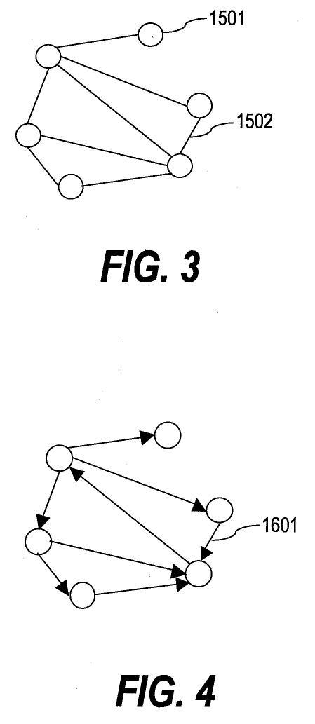

A graph is a diagrammatic expression of the relation between two terms, and shows the presence or absence of a relation R: V×V→{0, 1} between arbitrary two elements of a set V. In a graph, an element of the set V is represented by a node 1501 of FIG. 3. An edge 1502 connects one node with another when two elements u and v have a relation.

A directed graph is a diagrammical expression of an asymmetric binary relation. The relation R satisfies a symmetric law R (u, v)=R (v, u) in a graph whereas, in a directed graph, the symmetric law is not satisfied and a relation has directivity. Accordingly, a directed edge 1601 shown by the arrow of FIG. 4 is used in a directed graph to represent a relation having directivity.

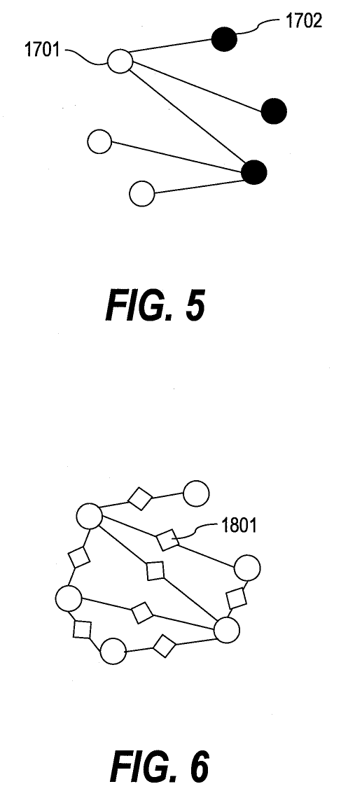

A bipartite graph shows the presence or absence of a relation R: U×V→{0, 1} between arbitrary elements of U and V, which are disjoint from each other. In a bipartite graph, of the two sets U and V, which are disjoint from each other, an element of the set U is represented by a node 1701, which is a white circle of FIG. 5, and an element of the set V is represented by a node 1702, which is a black circle of FIG. 5.

Generally, a bipartite graph is derived from a graph as the one shown in FIG. 3 by associating the edge 1502 with a new node 1801, which is represented by a square of FIG. 6.

A higher-order graph is a diagrammatical expression of a polynomial relation, and shows the presence or absence of a relation R: V×V× . . . ×V→{0, 1} among an arbitrary number of arbitrary elements of the set V. In a higher-order graph, a plurality of elements u, v, . . . w, which have a relation R(u, v, . . . w)=1, are connected to one another by higher-order edges (a pair consisting of a set of component output range sets and a union of component output range sets).

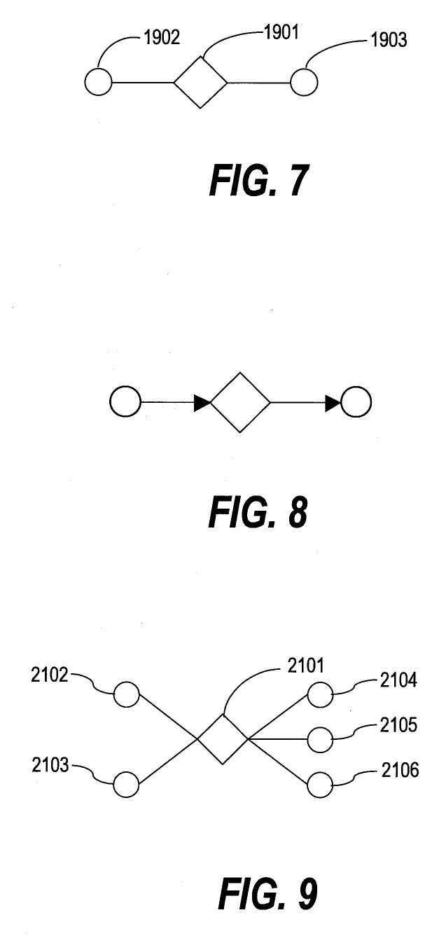

The aforementioned method of deriving a bipartite graph by associating an edge with a node is used to express a higher-order edge diagrammatically. FIG. 7 shows a bipartite graph expression of one edge in a graph of a bipartite graph derived from the graph of FIG. 6. In the case of a directed graph, an edge is given a bipartite graph expression of a directed edge in a directed graph as shown in FIG. 8. In FIG. 7, the presence of a binary relation is expressed by connecting two nodes 1902 and 1903 to a node 1901, which corresponds to an edge.

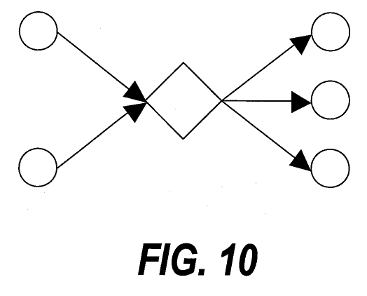

A higher-order graph, on the other hand, expresses the presence of a polynomial relation, as shown in FIG. 9, by connecting a plurality of nodes 2102 to 2106 to a node 2101, which corresponds to a higher-order edge. In the case of a directed higher-order graph, a directed polynomial relation is expressed as shown in FIG. 10. A higher-order graph is a diagrammatic expression using a set of nodes and a set of higher-order edges as the one shown in FIG. 9 or 10. This embodiment provides only a directed graph or a directed higher-order graph. Therefore, a directed graph and a directed higher-order graph will simply be referred to as graph and higher-order graph in the following description.

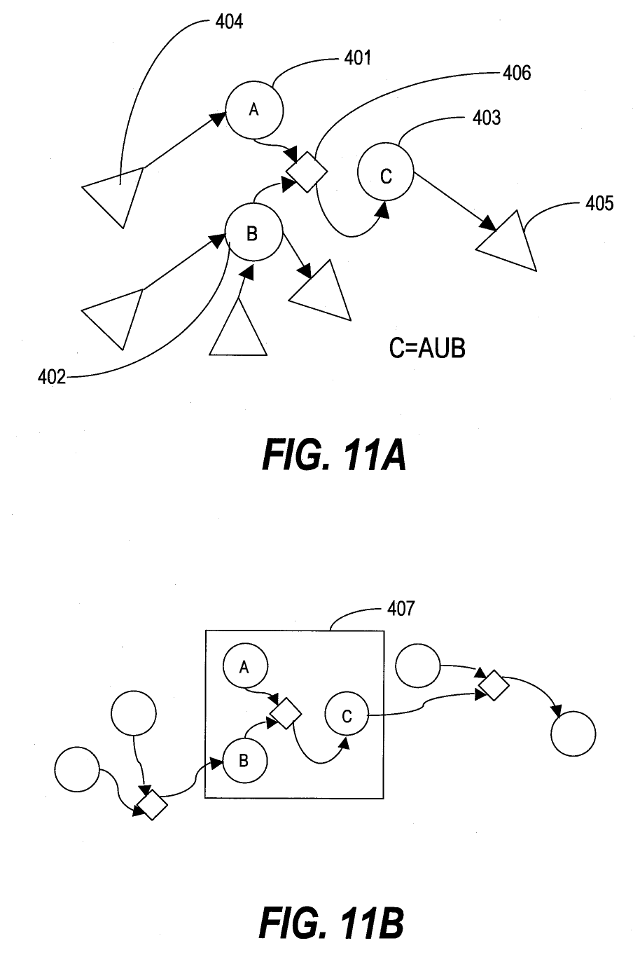

The concept of range set higher-order graph is shown in FIGS. 11A and 11B. FIG. 11A shows one higher-order edge and nodes that are in adjacent relation with the higher-order edge. Generally speaking, a higher-order graph is composed of sets of nodes 401 to 403 represented by circles in the drawing, and a set of higher-order edges 406 represented by a square in the drawing. The nodes 401 to 403 each correspond to a set of ranges. The higher-order edge 406 has two inputs and one output, and the output side corresponds to a union C of two input side range sets A and B. Input components 404 and output components 405 are attached to the nodes 401 to 403. A higher-order graph of FIG. 11B is obtained by connecting the higher-order edge of FIG. 11A and the edge's adjacent nodes, namely, a rectangular area 407 of FIG. 11B, to another rectangular area 407, and repeating this several times.

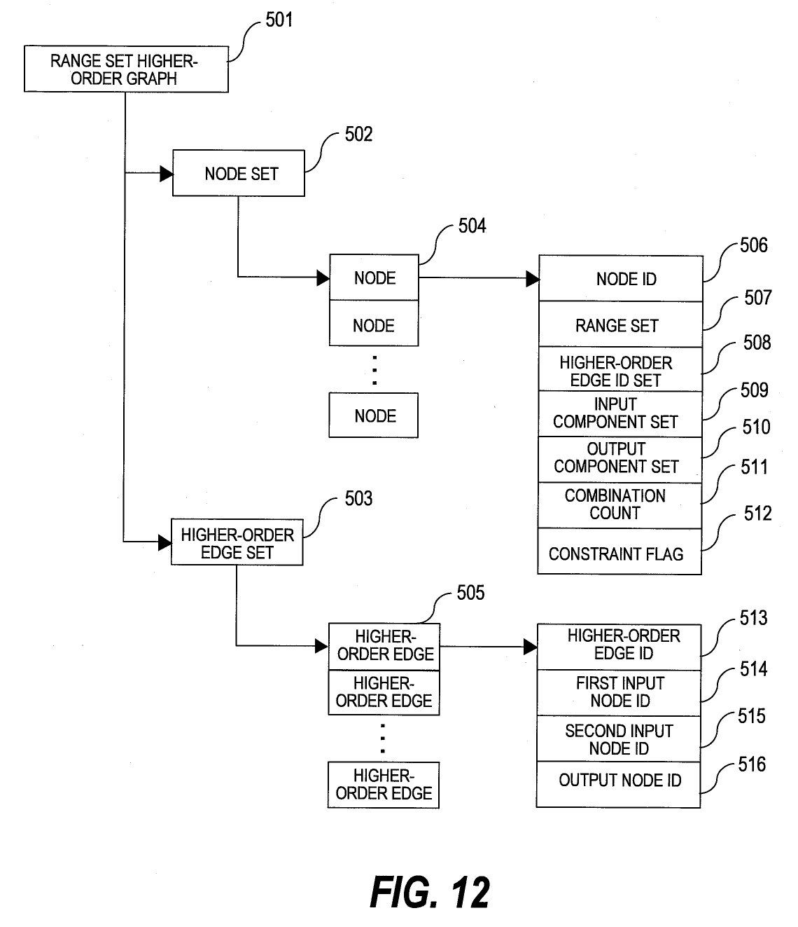

FIG. 12 shows the data configuration of a range set higher-order graph. A higher-order graph 501 is composed of a node set 502 and a higher-order edge set 503. For each of nodes 504 (the nodes 401 to 404 of FIG. 11A), a node ID 506, a range set 507, a higher-order edge ID set 508, an input component set 509, an output component set 510, a combination count 511, and a constraint flag 512 are recorded. Recorded as the node ID 506 is an index that is assigned to each node. A set of ranges that the node 504 represents is recorded as the range set 507. A list of higher-order edges 505 that are adjacent to the node 504 is recorded as the higher-order edge ID set 508. A set of components from which the range set 507 is output is recorded as the input component set 509. A set of components to which the range set 507 is input is recorded as the output component set 510. A value indicating how many components connected in parallel are necessary to accomplish the range set 507 is recorded as the combination count 511. A flag for judging whether to use this node 504 in search of this node set 502 is recorded as the constraint flag 512. Elements in the input component set 509 and the output component set 510 are universal resource identifiers (URI) of components (component URIs) which are identifiers indicating the location of the components.

For each higher-order edge 505, a higher-order edge ID 513, a first input node ID 514, a second input node ID 515, and an output node ID 516 are recorded. Recorded as the higher-order edge ID 513 is an index that is assigned to each higher-order edge. Indices assigned to input side nodes of the higher-order edge (reference numeral 406 shown in FIG. 11A) are recorded as the first input node ID 514 and the second input node ID 515. An index assigned to an output side node of the higher-order edge (reference numeral 406 shown in FIG. 11A) is recorded as the output node ID 516.

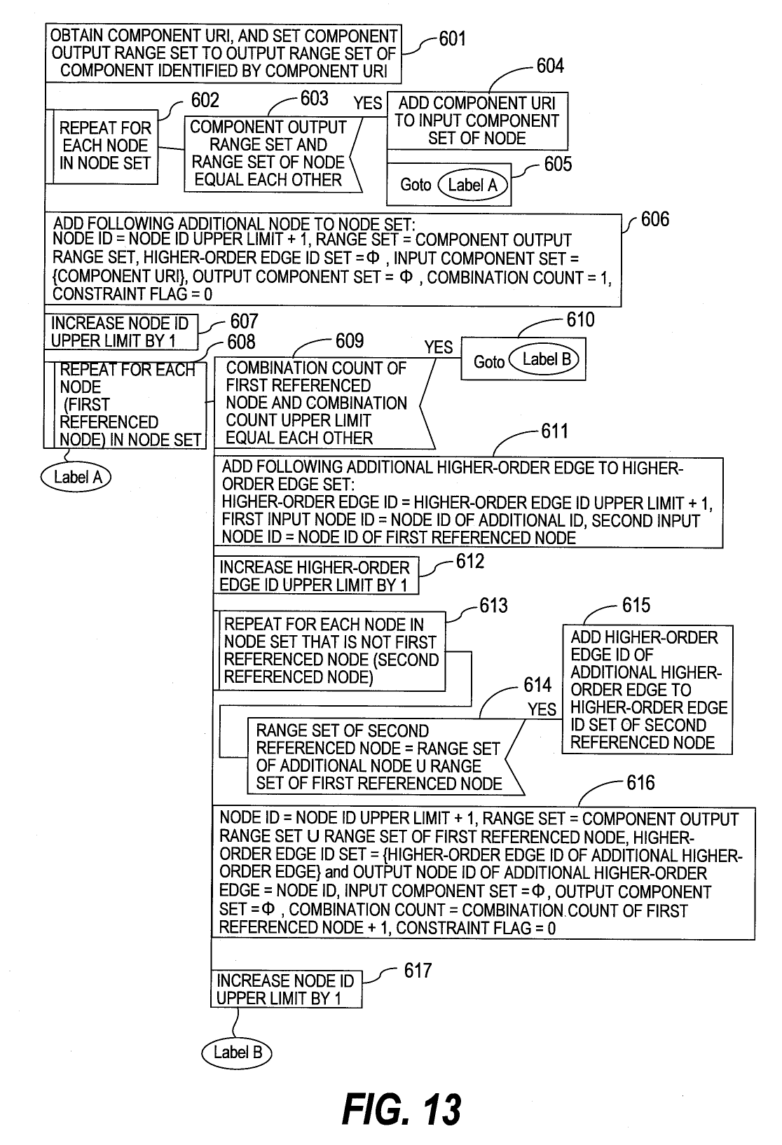

FIG. 13 is a problem analysis diagram (PAD) showing an example of the processing process of the component registration function 2301 of the range set higher-order graph management server 302 which is shown in FIG. 1. The component registration function 2301 registers, in the range set higher-order graph database 301, the components 202 stored in the software component repository 303 in the manner shown in FIG. 13.

First, the component registration function 2301 obtains component URIs via the registration/search user interface 2302 of the client 304 shown in FIG. 1, and records a component output range set (a set having the range set 507 as an input) as a set (the output component set 510) of output ranges of components identified by the obtained component URIs (601). In this processing, a component to be registered is designated by its URI through the registration/search user interface 2302 of the client 304. The component registration function 2301 reads the component designated by its URI out of the software component repository 303, and records the output range of this component in the component output range set.

Subsequently, whether or not the entered component output range set and the range set 507 of the node 504 are equal to each other is checked for each node 504 in the node set 502 shown in FIG. 12. When they are equal to each other, the component URI is added to the input component set 509 of the node 504, and the processing is ended (Steps 602 to 605). In this process, in the case where the range set 507 already exists in the range set higher-order graph database 301, the component is connected to this range set 507.

In the case where the range set 507 does not exist in Step 603, the following additional node is added to the node set 502 in Steps 606 and 607, and the node ID upper limit, which indicates the node count, is increased (Steps 606 and 607). The processing of those steps involves setting the aforementioned items as follows.

Node ID=node ID upper limit+1, range set=component output range set, higher-order edge ID set=φ, input component set={component URI}, output component set=φ, combination count=1, constraint flag=0 Expression (9)

Subsequently, the higher-order edge 505 is created that has, as inputs, the node 504 added in Steps 606 and 607 and another node 504 and that connects a union of the range sets 507 of those nodes (Step 608 to 617).

First, in Step 608, each node 504 in the node set 502 is referred to and classified as a first reference node. In Step 609, whether or not the combination count 511 of the first reference node equals to a combination count upper limit set in advance is judged in the range set higher-order graph database 301. When the combination count 511 of the first reference node smaller in number than the combination count upper limit, this processing is ended in Step 610 and the next node is examined. When the combination count 511 of the first reference node and the combination count upper limit equal to each other, the higher-order edge 505 is added to the higher-order edge set 503 in Step 611, and the higher-order edge ID upper limit is increased by 1 in Step 612. In Step 613, the range set comparison is performed for each node (second reference node) that is not a first reference node in the node set 502 to find out whether or not the added higher-order edge 505 already exists. This is achieved by judging, in Step 614, for each second reference node, whether or not the following conditional expression is satisfied.

Range set of second reference node=Range set of additional node∪Range set of first reference node

In Step 614, when the range set of the second reference node is a union of the range set of the additional node 504 and the range set of the first reference node, the higher-order edge ID 513 of the added higher-order edge 505 is added to the higher-order edge ID set 508 of the second reference node in Step 615. In Step 613, Steps 614 and 615 are executed for each second reference node. The added higher-order edge 505 is processed in Steps 616 and 617.

In the processing of creating the higher-order edge 505 of FIG. 13, no higher-order edge is created in a case where the count of combined components has already reached an upper limit (609 and 610). In other cases, the following additional higher-order edge is added to the higher-order edge set 503, and the higher-order edge ID upper limit, which indicates a higher-order variable, is increased (611 and 612). That is, Steps 611 and 612 involve processing the following Expression (10):

Higher-order edge ID=higher-order edge ID upper limit+1, first input node ID=node ID of additional node, second input node ID=node ID of first reference node Expression (10)

Subsequently, whether or not the output node 504 of the added higher-order edge 505 already exists is checked (613 and 614). In a case where the output node 504 already exists, the higher-order edge ID of the additional higher-order edge is added to the higher-order edge ID set 508 of the second reference node (615).

In other cases, the following expression is created for a node representing a union.

Node ID=node ID upper limit+1, range set=component output range set ∪ range set of first reference node, higher-order edge ID set={higher-order edge ID of additional higher-order edge} and output node ID of additional higher-order edge=node ID, input component set=φ, output component set=φ, combination count=combination count of first reference node+1, constraint flag=0 Expression (11)

### Then, the node ID upper limit, which indicates the node count, is increased (616 and 617).

Through the above-mentioned processing, the component registration function 2301 registers, in the range set higher-order graph database 301 which uses the range set higher-order graph 501 to manage a union of ranges of the components 202 stored in the software component repository 303, a component URI that indicates the location of the designated component 202, as an element of the input component set 509 or the output component set 510 in association with the range set 507.

FIG. 13 shows registration processing for a component that gives an input to the range set 507, that is, from the viewpoint of components, the range set 507 that is the output of a component. Registration processing for a component that receives an output from the range set 507 involves changing the output of a component to be processed into an input of the component, and switching the settings methods of the input component set and the output component set in Step 606.

Described above is a case in which the client 304 specifies the component 202 is to be registered. The component registration function 2301 executes the same processing that is shown in FIG. 13 also when it is the crawler 2304 that requests registration of the component 202.

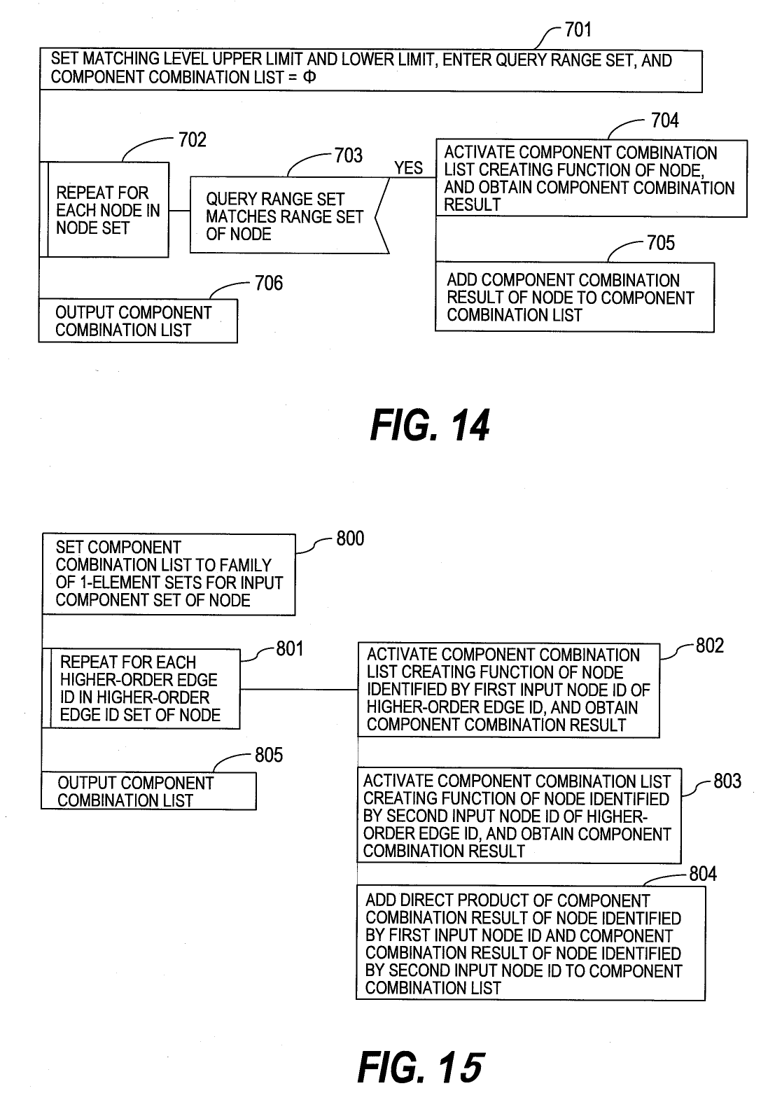

FIGS. 14 and 15 illustrate a recursion processing process performed by the component combination search function 2303 and the component combination list creating function 2306 which are shown in FIG. 1. In the recursion processing process, connection information of a component registered in the range set higher-order graph database 301 through the processing shown in FIG. 13 is retrieved, and the component combination list 2305 is output. This processing uses the range set 507 as a key, and outputs every component combination that matches the key. FIG. 14 shows the component combination search function 2303 and FIG. 15 shows the component combination list 2305 called by the component combination search function 2303.

The client 304 enters, as a query, a range set (input range set or output range set) of a component to be searched for through the registration/search user interface 2302, and makes an inquiry to the range set higher-order graph management server 302. The component registration function 2301 of the range set higher-order graph management server 302 uses the range set (hereinafter referred to as query range set) entered as a query to search the range set higher-order graph database 301, and outputs a parallel (or single) combination of the components 202 that matches (coincides with or approximates to) the query range set to the component combination list 2305.

The component combination search function 2303 shown in FIG. 14 first sets, in Step 701, matching level upper limit and lower limit for a query range set, enters the query range set as a query, and clears the component combination list 2305 (component combination list 2305=φ).

The matching level is defined as follows. The matching level is positive when a query range set is contained in the range set 507 of the node 504. This is called over-spec. matching. When there are N redundant ranges for a query range set, the matching level is N.

The matching level is negative when a query range set contains the range set 507 of the node 504. When there is a shortage of N ranges for a query range set, the matching level is −N. This is called under-spec. matching.

When the matching level is 0, a query range set coincides with the range set 507 of the node 504. This is called exact matching.

A positive, 0, or negative matching level is set through the client 304. It is also possible to set a preset matching level.

Subsequently, whether or not the query range set matches the range set 507 of the node 504 is checked for each node 504 in the node set 502 shown in FIG. 12. For the node 504 whose range set 507 matches the query range set, the component combination list creating function 2306 shown in FIG. 15 is activated to obtain a component combination result, add the component combination result to the component combination list 2305 (702 to 705), and output the component combination list (706).

When the query range set matches the range set 507 of the node 504, the processing proceeds to Step 704, where the component combination list creating function 2306, which will be described later, is activated to obtain a component combination result that matches the range set. In Step 705, the component combination result of the node 504 is added to the component combination list 2305.

FIG. 15 shows the component combination list creating function 2306 called by the component combination search function 2303 of FIG. 14. In the recursive node component combination list creating function shown in FIG. 15, the component combination list 2305 is first set to a family of 1-element sets of the input component set of the node 504 (800). A family of 1-element sets of a set {a, b, c} is {{a}, {b}, {c}}.

Next, for each higher-order edge ID 513 in the higher-order edge set of the node 504, the component combination list creating function 2306 of the node 504 that is identified by the first input node ID of the higher-order edge ID 513 is activated to obtain a component combination result, and the component combination creating function of the node that is identified by the second input node ID of the higher-order edge ID 513 is activated to obtain a component combination result in a recursive manner. Then the direct product of the component combination result of the node 504 that is identified by the first input node ID and the component combination result of the node 504 that is identified by the second input node ID are added to the component combination list 2305 (801 to 804).

The direct product of two families of sets {{a}, {b}} and {{c}, {d}} means {{a, c}, {a, d}, {b, c}, {b, d}}.

The component combination creating function of the node 504 is called in Step 704 of FIG. 14 and outputs a component combination list as a result (Step 805). The component combination list 2305 is, for example, a list containing the input component set 509 and the output component set 510 that are associated with the node set 507 within a range between the upper and lower limits of the matching level, and component URIs.

Through the above-mentioned processing, the input component set 509 and the output component set 510 for which the range set 507 and a range set (queiy range set) entered by the client 304 match at a given matching level are obtained from the range set higher-order graph database 301, and a parallel (or single) combination of components that has the entered query range set as an output is output as the component combination list 2305.

Unlike the above-mentioned conventional examples in which the connectability is checked for a plurality of components belonging to the universal set of all components, this invention structuralizes a family of subsets of the universal set of ranges, in other words, structuralizes in terms of components the universal set of range sets to which the input and output of components belong, and associates components to range sets contained in families of subsets of the universal set of ranges. In a search for a combination of software components (components) that has a range set as an output, a family of subsets (a set having subsets of ranges as elements) of the universal set of ranges that is structuralized in advance is utilized to find and extract a parallel (or single) combination of connectable components. This invention thus improves the search efficiency and reduces the load of computational processing compared to the prior art examples.

Further, a component combination extracted through the above-mentioned processing matches, at a given matching level, a query range set entered as a search condition. An application built by combining components (the input component set 509 and the output component set 510) that are output to the component combination list 2305 is guaranteed to operate normally since the match of the range sets is ensured. This invention thus makes it possible to guarantee the operation of an application created by combining a plurality of software components, and accordingly improves the software productivity.

For instance, when the input range set 204 and the output range set 205 are entered as a query range set, the component combination search function 2303 starts searching with the output ranges 205 as ranges to be searched. The component combination search function 2303 first searches for a parallel combination of the components 202 (or a single component) that outputs the output range set 205. The component combination search function 2303 next searches for a parallel (or single) combination of components that has as an output the input of the component combination (or the input of the component). This search is repeated in a loop until a component combination that coincides with or is contained in the input range set 204 received as a query range set. In this manner, component combinations that coincide with or approximate to a given query range set are searched for in succession from the output range side toward the input range side, and output to the component combination list 2305. A user of the client 304 can readily build an application that has matching input range and output range by combining optimum components 202 based on the search result on the component combination list 2305.

The range set higher-order graph database 301 and the software component repository 303 in the first embodiment are housed in different computers. However, the software component repository 303 may be housed in the range set higher-order graph management server 302.

### Second Embodiment

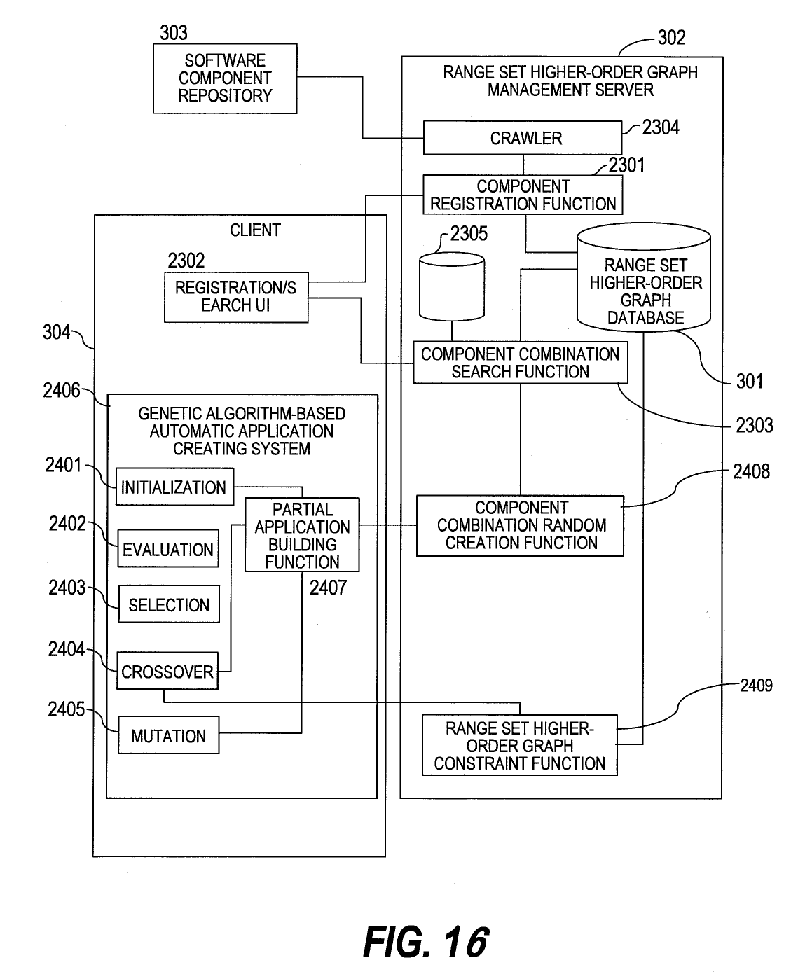

FIG. 16 is a block diagram of a computer system according to a second embodiment which automatically creates an application by applying genetic algorithms to a search result of the range set higher-order graph management server 302 of the first embodiment.

FIG. 16 differs from FIG. 1 of the first embodiment in that a component combination random creation function 2408, which uses the component combination search function 2303, is provided in the range set higher-order graph management server 302, and that an automatic application creating system 2406, which automatically creates an application by applying genetic algorithms, is added to the client 304. The rest of the configuration of the second embodiment is the same as the first embodiment.

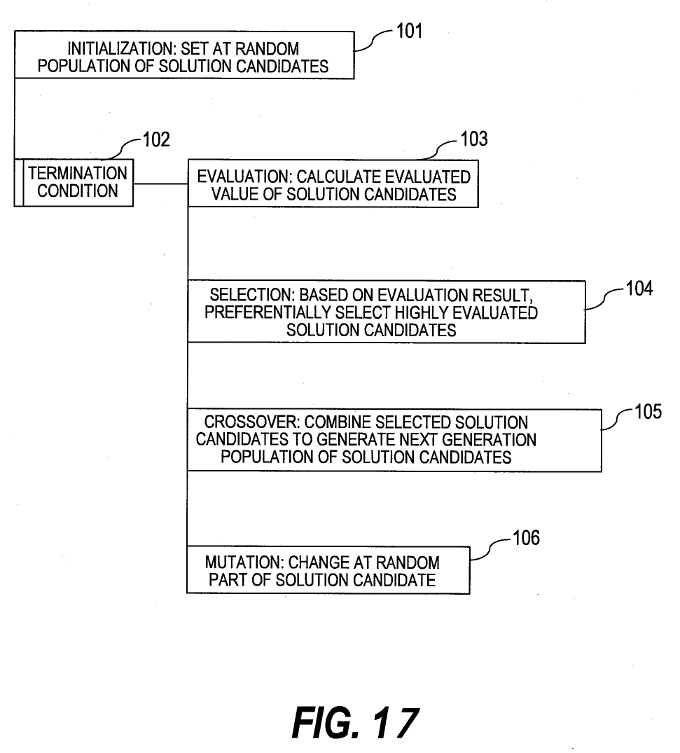

A description on the genetic algorithms will be given first with reference to FIG. 17.

The genetic algorithms are algorithms for obtaining an optimum solution by repeating a process of preparing a population of solution candidates, evaluating the solution candidates, preferentially selecting highly evaluated solution candidates, combining solution candidates through a process called crossover, and partially rewriting a solution candidate through a process called mutation to generate a new solution candidate.

In an initialization process 101 of FIG. 17, a population of a plurality of solution candidates is set at random. Evaluation, selection, crossover, and mutation processes are repeatedly performed on the population of solution candidates until a termination condition 102 is met. The termination condition 102 is based on, for example, the repetition count or a change in evaluated value. In an evaluation process 103, evaluated values of the solution candidates are calculated. In a selection process 104, solution candidates highly evaluated in the evaluation process 103 are preferentially selected. In a crossover process 105, the selected solution candidates are combined to generate the next generation population of solution candidates. In a mutation process 106, solution candidates are partially changed at random. The genetic algorithms are optimization algorithms accomplished through repetition of those processes.

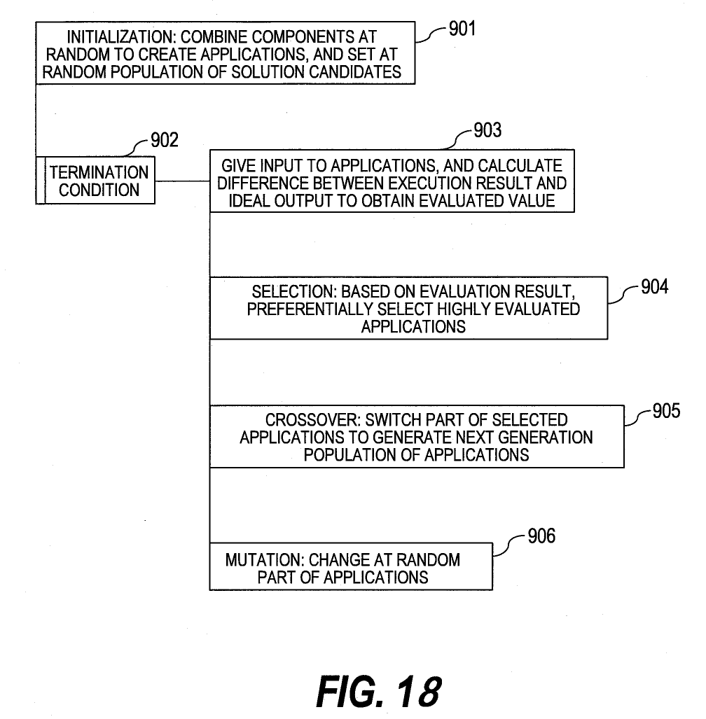

FIG. 18 shows a case in which the genetic algorithms of FIG. 17 is applied to the automatic application creating system 2406. Discussed here is an object of creating an application that meets the input-output relation of pairs of input and ideal output.

In an initialization process 901 of FIG. 18, components are combined at random to create an application, and applications created in this manner are used as solution candidates to set a population of solution candidates at random. An evaluation process 903, a selection process 904, a crossover process 905, and a mutation process 906 are repeatedly performed on the population of solution candidates until a termination condition 902 including the repetition count and a change in evaluated value is met.

In the evaluation process 903, a plurality of inputs and ideal outputs are given, and a solution candidate is evaluated by calculating the difference between the solution candidate's result of executing one of the inputs and the ideal result associated with the input. In genetic algorithms, an evaluation result is usually expressed by a numerical value equal to or larger than 0 which is called fitness. In the selection process 904, highly evaluated applications are preferentially selected based on their evaluation results. Preferential selection means, for example, selecting solution candidates at a ratio in proportion to the numerical value called fitness. This method is called roulette wheel selection. The roulette wheel selection repeats, as many times as the number of applications, a process of obtaining the sum of fitness values of the applications in the population, dividing the fitness of each application by the sum to make the sum 1, dividing an interval [0, 1] by the fitness, allocating each interval section to an application, generating random numbers that follow a uniform distribution pattern having [0, 1] as the range, and choosing, in other words, copying an application that is associated with an interval section containing that value.

In the crossover process 905, the selected applications are paired and some pairs are switched in a manner described below to generate the next generation population of solution candidates. Pairing of applications follows, for example, a rule that, when the applications in the population are indexed, applications having adjacent indices are paired (the first and second applications make a pair and the third and fourth applications make another pair). In the mutation process 906, random numbers that follow a uniform distribution pattern having [0, 1] as the range are created for each application in the population and, when that value is equal to or smaller than a given value, a part of the application is changed in a manner described below. The genetic algorithms are optimization algorithms accomplished through repetition of those processes.

In the processes of FIG. 18, when applications are created, combined, or changed in the initialization process 901, the crossover process 905, and the mutation process 906, it is necessary to judge the connectability of components and the range set higher-order graph management server 302 of the first embodiment is used to make the judgment.

The client 304 of FIG. 16 runs the automatic application creating system 2406 which automatically creates an application with the use of the genetic algorithms described above. The automatic application creating system 2406 contains genetic algorithms, which perform optimization using an initialization function 2401, an evaluation function 2402, a selection function 2403, a crossover function 2404, and a mutation function 2405, and a partial application building function 2407, which is used in the initialization 2401, the crossover 2404, and the mutation 2405 and plays an essential role in this invention.

The range set higher-order graph management server 302 of FIG. 16 is provided with the component combination random creation function 2408 and a range set higher-order graph constraint function 2409. The component combination random creation function 2408 selects at random software component combination results from search results of the component combination search function 2303 called by the genetic algorithms-based automatic application creating system 2406 and partial application building function 2407 of the client computer 304. The range set higher-order graph constraint function 2409 is called by the crossover function 2404 of the automatic application creating system 2406 of the client 304 to set and cancel. The rest of the function modules in the second embodiment are the same as in the first embodiment.

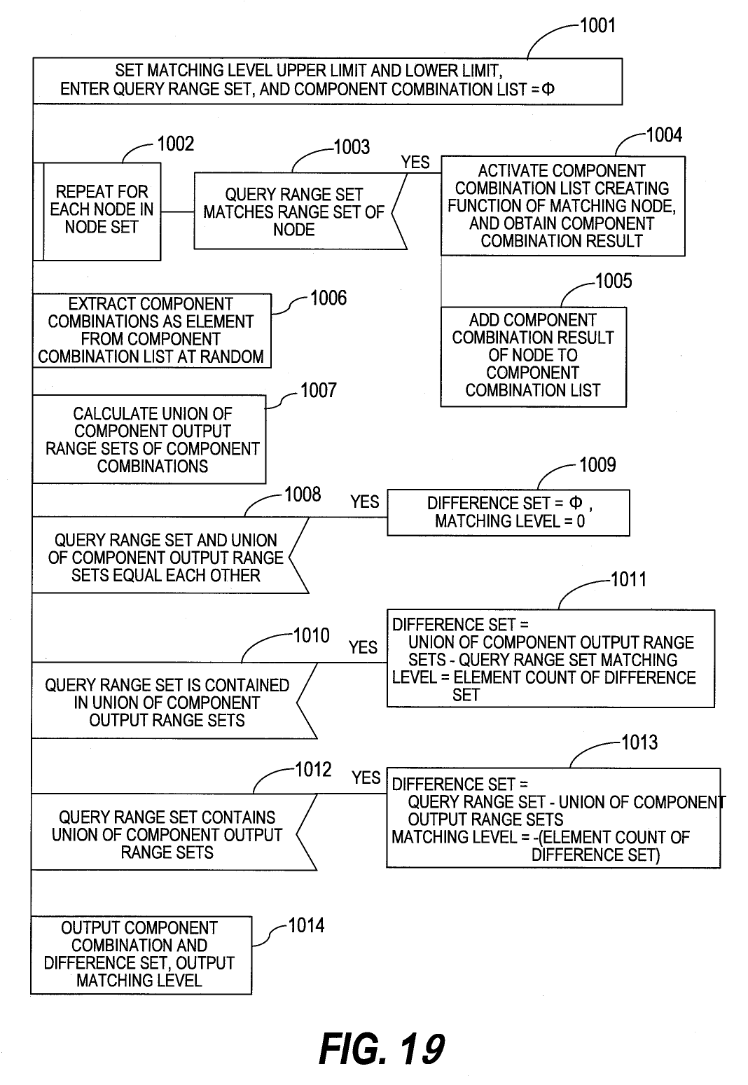

FIG. 19 illustrates the processing process of the component combination random creation function 2408 of the range set higher-order graph management server 302 shown in FIG. 16. This function is used by the genetic algorithms of the automatic application creating system 2406 in the client 304. Therefore, the component combination random creation function 2408 randomly chooses a component search result from search results provided by the component combination search function 2303 of the first embodiment (1002 to 1006), and calculates the matching level of the chosen result and a difference set of an output range set of a component combination and a query range set given as a query search (1007 to 1014). The difference set is a subset of query range sets that is not processed by component combinations. The query range set is, as in the first embodiment, a range set entered as a query through the registration/search user interface 2302 of the client 304.

Steps 1001 to 1005 of FIG. 19 are the same as Steps 701 to 705 of FIG. 14 described in the first embodiment, and component combinations that match a query set entered are output to the component combination list 2305.

In Step 1006, component combinations and component URIs indicating the location of the components are selected at random from the component combinations output to the component combination list 2305. The random selection is made by generating pseudo-random numbers or random numbers through a suitable known method.

In Step 1007, a union of component output range sets (507) is obtained from the selected component combinations. When it is found in Step 1008 that the union obtained in Step 1007 equals the query range set entered, the difference set is turned into an empty set φ and the matching level is set to 0 in Step 1009.

In Step 1010, whether or not the union obtained in Step 1007 is contained in the entered query range set is checked. When the union is contained in the query set range, the difference set and the matching level are defined in Step 1011 such that the difference set is obtained by subtracting the query range set from the union of component output range sets and that the matching level equals the element count of the difference set. In short, the matching level is the positive value described above.

When it is found in Step 1012 that the query range set entered is contained in the union obtained in Step 1007, the difference set and the matching level are set in Step 1013 as follows.

Difference set=query range set−union of component output range sets

Matching level=−(element count of difference set)

The thus calculated difference set and matching level are output in Step 1014 as a result of random selection of component combinations.

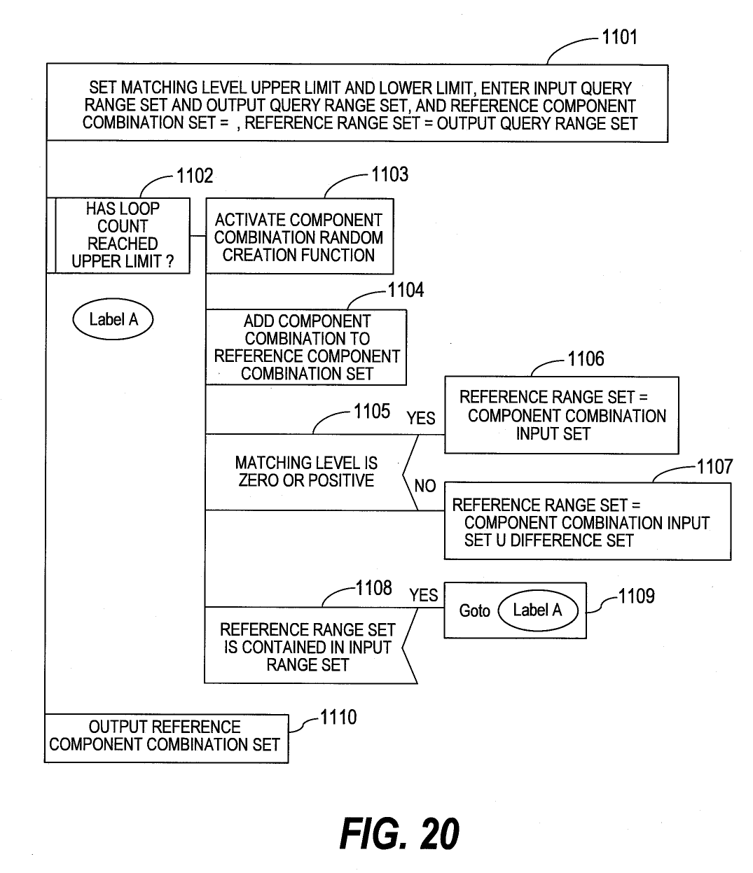

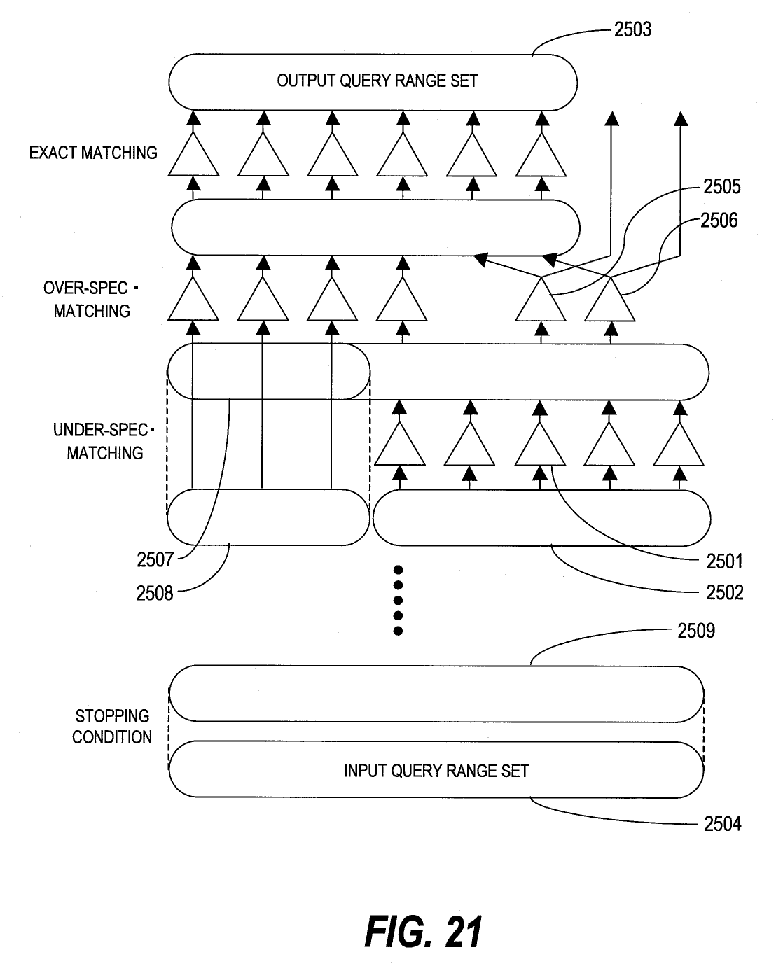

Described next with reference to FIGS. 20 and 21 is a processing process for creating the application 201 and partial application 203 shown in FIG. 2 from an input range set and an output range set. The processing shown in FIG. 20 repeats searching for a combination of software components 2501 shown in FIG. 21 with the use of the component combination random creation function 2408 and overwriting an entered range set 2502 with the input of the combination of the components 2501.

In FIG. 20, as in FIG. 14 of the first embodiment, matching level upper limit and lower limit are set first, an input query range set 2504 and an output query range set 2503 are entered, and a reference component composition set and a reference range set are defined such that the reference component composition set is empty (φ) and the reference range set equals the output query range set (Step 1101).

Thereafter, processing of Step 1103 and processing of Steps 1104 to 1107 are repeated until the repetition count reaches a preset upper limit (1102), or until a component combination is created that enables the system to calculate the output query range set 2503 from the input query range set 2504, in other words, until a range set 2509 obtained by repetitive overwriting of the range set 2502 coincides with the input range set 2504 (1108 and 1109). The processing of Step 1103 is to activate the component combination random creation function 2408. The processing of Steps 1104 to 1107 is to overwrite the reference range set with a union of subsets 2307 and 2308 of a query range set that is not processed by component combinations and the component input range set 2302. In over-spec. matching, unused software component outputs 2505 and 2506 are created as shown in FIG. 21.

This processing is for obtaining, as a set, a combination of components constituting a partial application from an input range set and an output range set.

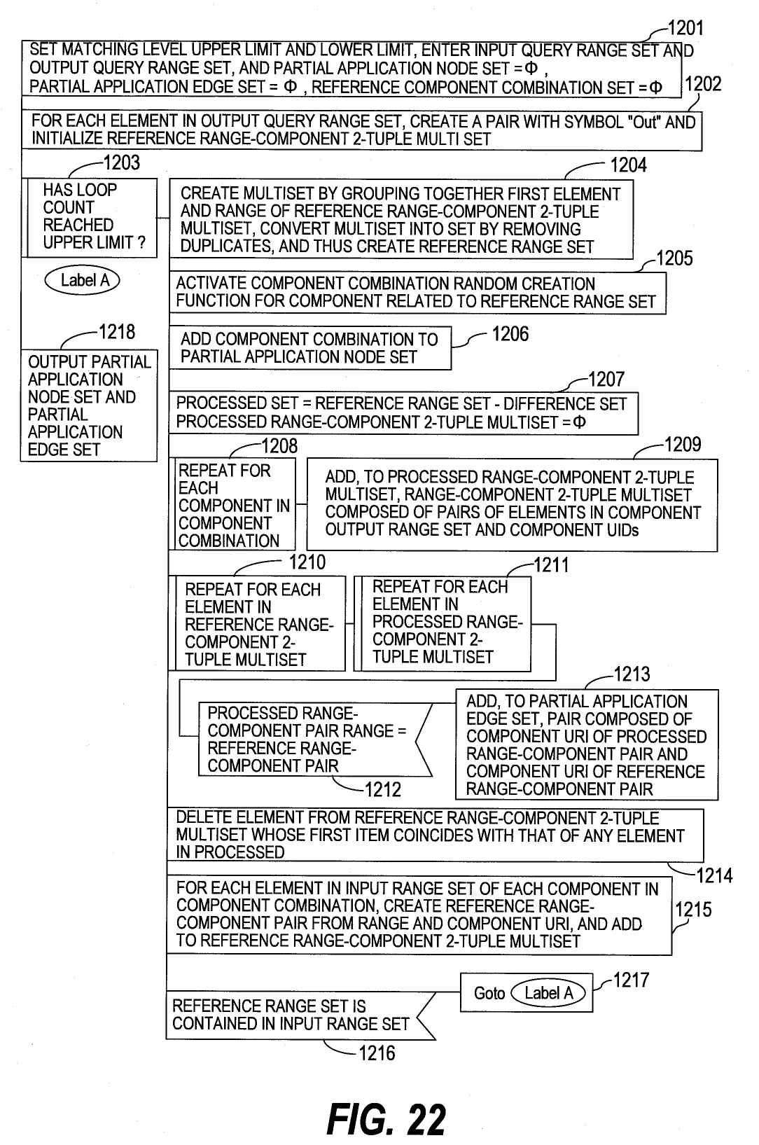

Shown in FIG. 22 is partial application building processing which is performed by the partial application building function 2407 of the automatic application creating system 2406 in order to obtain the configuration of a partial application instead of a component combination. Two pieces of data, a partial application graph and a range-component 2-tuple multiset, are used here. Those two pieces of data will be described first.

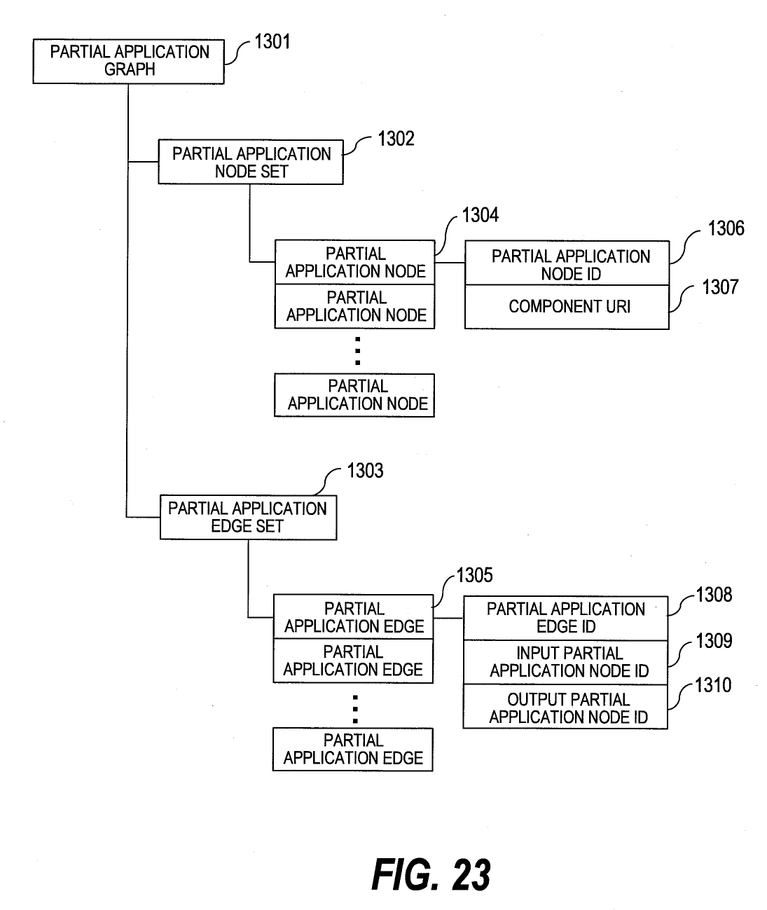

FIG. 23 shows the data configuration of a partial application graph. This graph shows components used in the partial application 203 and how the components are connected. A partial application graph 1301 is composed of a partial application node set 1302 and a partial application edge set 1303. Each partial application node 1304 has as the index of the node a partial application node ID 1306 and a component URI 1307. The partial application node 1304 corresponds to a component. Each partial application edge 1305 has as the index of the edge a partial application edge ID 1308, an input partial application node ID 1309, and an output partial application node ID 1310. A partial application edge indicates that a component of a node identified by the input node ID 1309 and a component of a node identified by the output node ID 1310 are connected. A component connection corresponds to a chromosome in genetic algorithms.

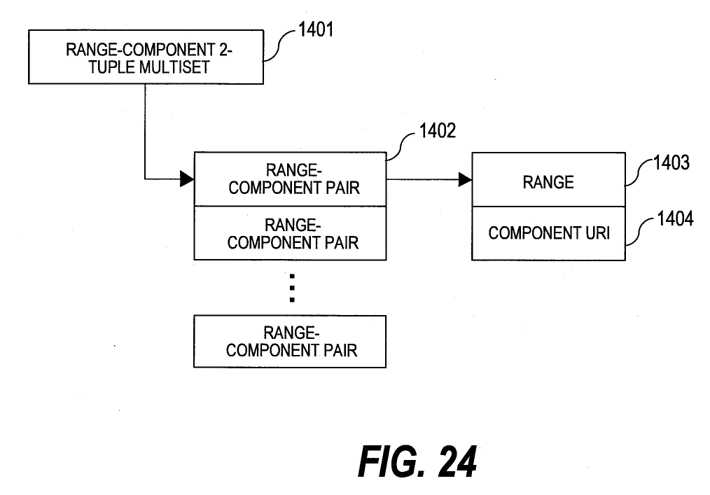

FIG. 24 shows the data configuration of a range-component 2-tuple multiset. This set is for recording a pair of a component 1404 and a range sets 1403. A multiset is a set that allows overlapping of elements.

The configuration of a partial application is as shown in FIG. 23, and is represented by the partial application graph 1301. The partial application node set 1302 of the partial application graph 1301 can be obtained by the algorithm of FIG. 20.

The processing of FIG. 22 is executed in order to obtain the partial application edge set 1303. First, in Step 1201, initialization is carried out by setting matching level upper limit and lower limit in the manner described above, entering an input query range set and an output query range set, and defining the partial application node set 1302, the partial application edge set 1303, and a reference component combination as empty sets (partial application node set 1302=φ, partial application edge set 1303=φ, reference component combination=φ).

Next, two range-component 2-tuple multisets configured as shown in FIG. 24 are used. One is a reference range-component 2-tuple multiset and the other is a processed range-component 2-tuple multiset. The reference range-component 2-tuple multiset is initialized by assuming the presence of a component that is an external environment having elements of the output query range set as an input, and by forming pairs with the virtual component “Out” (1202).

The component combination random creation function 2408 is activated for a range set that is calculated from the reference range-component 2-tuple multiset, and outputs a component combination (1204 to 1206).

In Step 1204, a multiset is created by grouping together first elements and ranges of the reference range-component 2-tuple multiset, the multiset is converted into a set by removing duplicates, and a reference range set is thus created.

In Step 1205, the component combination random creation function 2408 is activated in order to select a combination of components related to the created reference range set.

In Step 1206, randomly selected component combinations are added to the partial application node set 1302.

In Step 1207, a processed set and the processed range-component 2-tuple multiset are defined as follows.

Processed range=reference range set−difference set

Processed range-component 2-tuple multiset=φ

A processed range-component multiset shows the association between a component output range set and a component (1208 and 1209). Ranges of elements of those two range-component multisets are compared and elements having the same range are connected to constitute a partial application edge (1210 to 1214).

In Steps 1208 and 1209, a range-component 2-tuple multiset composed of pairs of elements in an output range set of a component and component UID (URI) is added to the processed range-component 2-tuple multiset. This processing is repeatedly executed to process each component in a combination of components.

In Steps 1210 to 1213, Steps 1212 and 1213 are repeated for each element in the processed range-component 2-tuple multiset. In Step 1212, whether or not a range of a processed range-component pair and a range of a reference range-component pair equal to each other is judged. When the two are equal, a pair constituted of a component URI of the processed range-component pair and a component URI of the reference range-component pair is added to the partial application range set in Step 1213. In Step 1214, an element is deleted from the reference range-component 2-tuple multiset whose first item coincides with that of any element in the processed set.

In Step 1215, a reference range-component pair is formed from a range and a component URI for each element in the input range set of each component in a combination of components, and the formed pair is added to the reference range-component 2-tuple multiset to thereby update the reference range-component 2-tuple multiset.

Created through the above-mentioned processing is a partial application corresponding to an output query range set, namely, a set in which a plurality of components are connected.

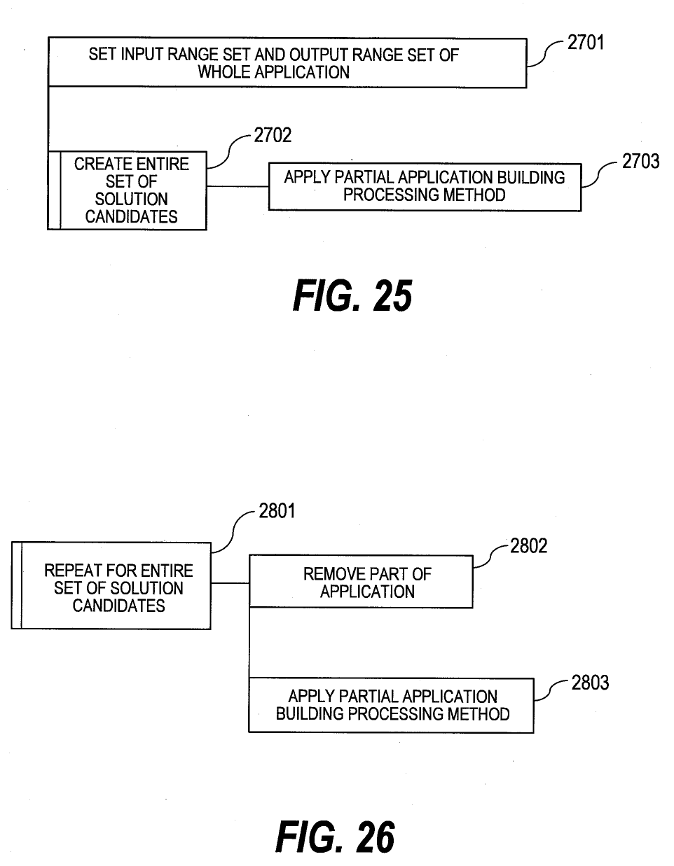

With the partial application building processing, initialization, crossover, and mutation processes in genetic algorithms-based automatic application creation are formed as follows. In the initialization process, as shown in FIG. 25, an input range set and output range set of the whole application are set (2701), the partial application building processing is applied (2703), and creation of an application as a solution candidate is repeated to create a population of solution candidates (2702).

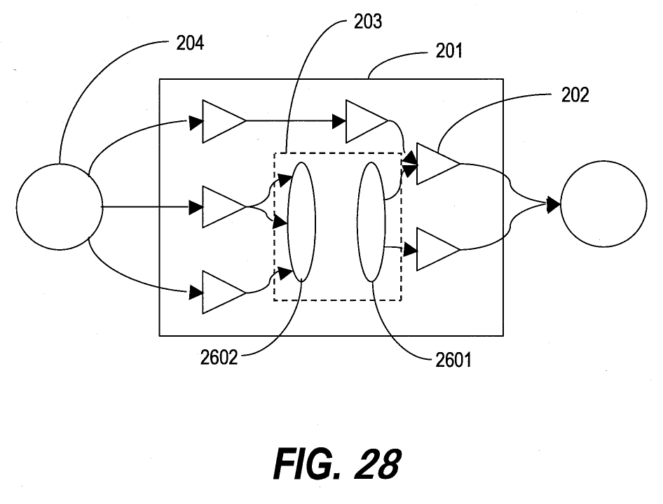

In the mutation process, as shown in FIG. 26, some of components of an application as a solution candidate are selected at random, and the selected components are removed (2802). This makes inputs to some components insufficient whereas outputs from other components are unused as shown in FIG. 28. Next, a union of input range sets of components with insufficient inputs is considered as a query output range set 2601 and an output range set of components with unused outputs is considered as a query input range set 2602. The partial application building processing is applied to those query range sets (2803). This process is repeated for every application as a solution candidate (2801).

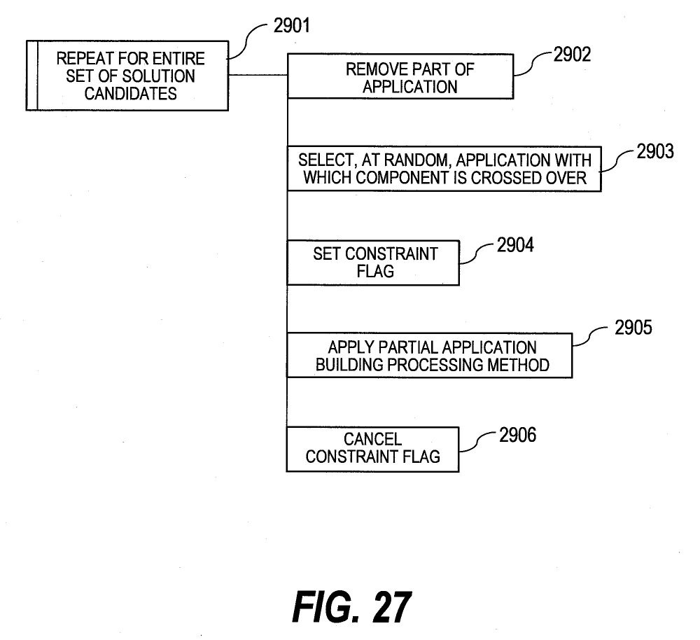

In the crossover process, as shown in FIG. 27, some of components of an application as a solution candidate are selected at random and the selected components are removed (2902). Next, one solution candidate application is chosen to be crossed over with the partially removed application based on a given condition (2903). The range set higher-order graph constraint function 2409 of FIG. 16 is used in the crossover process to set the constraint flag 512 shown in FIG. 12 only to components of the application to be crossed over (2904), and a component search is performed with the use of the flag. The partial application building processing is then applied (2905). The constraint flag 512 is canceled after the partial application building processing is applied (2906). This process is repeated for every application as a solution candidate (2901).

As described above, in automatic creation of an application using genetic algorithms, this invention creates solution candidates by searching an input range set of software components for a connectable combination of software components instead of directly judging the connectability of software components in the processes of initialization, crossover, and mutation. Producing a solution candidate that is not evaluative is thus avoided, and the software productivity is greatly improved.

As has been described, this invention is applicable to an automatic application building system which automatically creates an application from a software component repository or the like, a software component management system which manages a software component repository, and other similar systems.

While the present invention has been described in detail and pictorially in the accompanying drawings, the present invention is not limited to such detail but covers various obvious modifications and equivalent arrangements, which fall within the purview of the appended claims.

What is claimed is:

1. A search engine for software components, which searches a plurality of preset software components for software components that meet an entered condition, comprising:
a software component storage unit which stores a set having, as elements, ranges that define input and output of a plurality of software components;
a higher-order graph which is used to manage a union of output range sets and an input range of the software components, and identifiers of the software components;
a search condition receiving unit which receives a range of a software component to be extracted from the higher-order graph; and
a search unit which searches, based on the received range, the union of output range sets in the higher-order graph for one of a parallel combination of software components and a single software component having the received range as an output.

2. A search engine for software components according to claim 1,
wherein the search condition receiving unit receives an output range and input range of a software component to be searched for, and
wherein the search unit searches software components, which contain the received output range out of the union of output range sets in the higher-order graph, for a software component whose input range contains the received input range.

3. A search engine for software components according to claim 1, wherein the search unit sequentially searches software components, which contain the received output range out of the union of output range sets in the higher-order graph, for a software component whose input range contains the received input range.

4. A search engine for software components according to claims 1, further comprising an application creating unit which creates an application from search results of the search unit by using genetic algorithms,
wherein the application creating unit includes:
an initialization unit which selects at random the software components to create a plurality of applications as a population of solution candidates;
an evaluation unit which evaluates the applications in the population of solution candidates;
a selection unit which chooses one application out of the plurality of applications based on a result of the evaluation;
a crossover unit which replaces a part of the chosen application with other software components to create a next generation population of applications; and
a mutation unit which creates a new population of applications by replacing a part of the chosen application with randomly selected other software components, and
wherein the initialization unit enters, in the search condition receiving unit, an input range and an output range that are set in advance, and combines software components retrieved by the search unit, to create a plurality of applications.

5. A search engine for software components according to claim 4, wherein the mutation unit partially removes the chosen application by removing some of software components of the chosen application, enters, in the search condition receiving unit, input and output of the removed components as a range, and inserts software components retrieved by the search unit into the partially removed application in place of the removed components.

6. A search engine for software components according to claim 4, wherein the crossover unit partially removes the chosen application by removing some of software components of the chosen application, selects another application from the solution candidates, and inserts software components of the other selected application into the partially removed application in place of the removed components.

7. A search program for software components, which causes a computer to execute a processing of searching a plurality of preset software components for software components that meet an entered condition, the search program for software components causes the computer to execute the steps of:
storing a set having, as elements, ranges that define input and output of a plurality of software components;
setting a higher-order graph which is used to manage a union of output range sets and an input range of the software components, and identifiers of the software components;
receiving a range of a software component to be extracted from the higher-order graph; and
searching, based on the received range, the union of output range sets in the higher-order graph for one of a parallel combination of software components and a single software component having the received range as an output.

8. A search program for software components according to claim 7,
wherein the step of receiving a range includes receiving an output range and input range of a software component to be searched for, and
wherein the step of searching includes searching software components, which contain the received output range out of the union of output range sets in the higher-order graph, for a software component whose input range contains the received input range.

9. A search program for software components according to claim 7, wherein the step of searching includes sequentially searching software components, which contain the received output range out of the union of output range sets in the higher-order graph, for a software component whose input range contains the received input range.

10. A search program for software components according to claims 7, further comprising the step of creating an application from search results of the search unit by using genetic algorithms,
wherein the step of creating an application includes the steps of:
selecting at random the software components to create a plurality of applications, set the created software components as a population of solution candidates, and initializing the population of solution candidates;
evaluating the applications in the population of solution candidates;
choosing one application out of the plurality of applications based on a result of the evaluation;
creating a next generation population of applications by replacing a part of the chosen application with other software components; and
replacing a part of the chosen application with randomly selected other software components to create a new population of applications, and updating the population of solution candidates, and
wherein the step of initializing includes receiving as ranges an input range and an output range that are set in advance, and combines software components retrieved in the step of searching, to create a plurality of applications.

11. A search program for software components according to claim 10, wherein the step of updating the population of solution candidates includes the steps of:
partially removing the chosen application by removing some of software components of the chosen application; and
inserting software components retrieved in the step of searching into the partially removed application, input and output of the removed components as a range, in place of the removed components.

12. A search program for software components according to claim 10, wherein the step of creating a next generation population of applications includes the steps of:
partially removing the chosen application by removing some of software components of the chosen application; and
selecting another application from the solution candidates and inserting software components of the other selected application into the partially removed application in place of the removed components.

13. A computer system, comprising:
a client computer; and
a server,
the client computer entering a condition in the server,
the server being connected to the client computer and searching a plurality of preset software components for software components that meet the condition,
wherein the server includes:
a software component storage unit which stores a set having, as elements, ranges that define input and output of a plurality of software components;
a higher-order graph which is used to manage a union of output range sets and an input range of the software components, and identifiers of the software components;
a search condition receiving unit which receives, from the client computer, a range of a software component to be extracted from the higher-order graph; and
a search unit which searches, based on the received range, the union of output range sets in the higher-order graph for one of a parallel combination of software components and a single software component having the received range as an output.

14. A computer system according to claim 13,
wherein the server further includes an application creating unit which creates an application from search results of the search unit by using genetic algorithms,
wherein the application creating unit includes:
an initialization unit which selects at random the software components to create a plurality of applications as a population of solution candidates;
an evaluation unit which evaluates the applications in the population of solution candidates;
a selection unit which chooses one application out of the plurality of applications based on a result of the evaluation;
a crossover unit which replaces a part of the chosen application with other software components to create a next generation population of applications; and
a mutation unit which creates a new population of applications by replacing a part of the chosen application with randomly selected other software components, and
wherein the initialization unit enters, in the search condition receiving unit, an input range and an output range that are set in advance, and combines software components retrieved by the search unit, to create a plurality of applications.
